(19) United States
(12) Patent Application Publication
(10) Pub. No.: US 2008/0127020 A1
(43) Pub. Date: May 29, 2008

(54) System and method for automatic elimination of voltage drop, also known as IR drop, violations of a mask layout block, maintaining the process design rules correctness

(76) Inventor: Dan Rittman, Atlit (IL)

Correspondence Address: DANNY RITTMAN, P.O. 2040, Atlit, 30300, omitted

(21) Appl. No.: 11/585,604

(22) Filed: Oct. 25, 2006

(51) Int. Cl. G06F 17/50

(52) U.S. Cl. 716/10; 716/5

(57) ABSTRACT

A system and method for automatic correction of voltage drop, also known as IR Drop violations of a mask layout block, maintaining the process design rules (DRC Clean) and layout connectivity (LVS Clean) correctness, are disclosed. The method includes analyzing polygons or signals for voltage drop violations, in a mask layout block and obtaining one or more voltage drop restriction information associated with polygons or signals from a technology and an external constraints file. The system automatically corrects all voltage drop violations if found, changing polygons space, width and length, maintaining the process design rules (DRC Clean) and layout connectivity (LVS Clean) correctness. The method also includes analysis and automatic correction of contacts and VIA's according to amount and location in order to comply with voltage drop requirements as taken from technology or external constraints file. The method provides a violation marker associated with position of polygons or signals that graphically represents a width, space, length violation. The method and system works on GDSII format files and on industry standards layout editor's database.

### BACKGROUND OF INVENTION

1. Technical Field of the Invention

The present invention is generally related to the field of integrated circuits, and more particularly to a system and method for automatic correction of voltage drop violations within a mask layout block in the metallic, polysilicon, contacts and VIA's interconnects of an integrated circuit device, maintaining the process design rules (DRC Clean) and layout connectivity (LVS Clean) correctness.

2. Background of the Invention

Nanometer designs contain millions of devices and operate at very high frequencies. The current densities (current per cross-sectional area) in the signal lines and power are consequently high and can result in either signal or power electromigration problems. Microelectronic integrated circuits (ICs), such as computer chips, are used in a variety of products including personal computers, automobiles, communication systems, and consumer electronics products. As modern day ICs become increasingly more powerful, their internal circuitry become increasingly more complex. A present day IC usually contains millions of microscopic circuit structures such as transistors, resistors, and capacitors on a small silicon die or core. Typically, the entire silicon core is encapsulated in plastic or ceramic, with a number of lead pins exposed to the outside world.

Power is generally supplied to the IC through one or more of these lead pins. Bond wires typically conduct the power from the lead pins to power pad cells located on the core. The power pad cells connect to a power-bus grid comprising of thin metal wires which route power to IC structures throughout the core. A power-bus grid is typically constructed on several vertical layers, with the number of layers dependent on the IC fabrication technology used. All the power-bus wires are generally routed running parallel to either the width (horizontally-oriented wires) or the length (vertically-oriented wires) of the core. Power-bus layers are usually named Metal 1, Metal 2, Metal 3, and so on, with Metal 2 located above Metal 1, Metal 3 located above Metal 2, and so on. Generally, each layer is connected to the layer immediately above it by metal plugs or vias which run between intersecting wire lines. The power-bus grid is typically connected to the rest of the IC structures with plugs or contacts running from the Metal 1 bus lines to the IC transistors.

One of the main factors helping to increase the performance and complexity of modern ICs is the use of Computer-Aided Design (CAD) tools during the IC design process. In addition to simplifying the design process, CAD tools can help speed up the development time of an IC by automating much of the design process. This decreases the time and cost necessary to develop an IC and helps the designer create more competitive products in the market.

A typical IC design process begins with a design specification. The specification is set by the goals and limitations of the design project. For example, a design application specified for use in a portable device may require the IC to operate using a low voltage power supply. Generally, the specification helps the designer determine the IC fabrication technology, supply voltage, and core size needed to implement the design.

Next, an abstract representation of the circuit is created by the designer. Circuit abstraction helps the designer focus on the behavioral aspects of the design without having to worry about low-level circuit theory and device physics details. Designers typically work in a top-down methodology, starting with a behavioral description and working down to more detailed register, gate, and switch levels of abstraction. Designers generally use a Hardware Description Language (HDL) such as VHDL to abstract the circuitry of an IC. HDL is similar to a high level programming language and typically includes libraries containing a set of circuit components supported by the targeted fabrication process. This helps ensure the HDL code written can be converted to a real-life product.

The abstracted code is generally converted into a database listing or a circuit netlist. A netlist is typically a list of individual circuit components with a description of the connections between their inputs and outputs. Since the netlist is produced from a behavioral description of the circuitry, it does not include information relating to the physical position of the circuit structures in the circuit. Therefore, information such as the distance of power-bus wires connecting to the circuit structures is usually not contained in the netlist.

The netlist is generally input to a simulator which performs a pre-layout simulation of the circuit design. Simulation permits the designer to test whether a particular design works before it is built. By using mathematical models for physical devices, a simulator can provide simulated output results for circuit designs. By comparing the simulation results with the expected simulation output, the designer can make sure the design works before actually building the IC. If the simulation results do not conform to the original design objectives, the designer can return to the HDL code and adjust the design accordingly. The designer may also use a simulator to compare several design approaches to each other and find the most favorable design approach.

Since the physical layout of the circuit is not specified in the netlist, ideal power-bus grid wires are typically assumed during the pre-layout simulation. Thus, the resistance of the wires supplying current to the IC is generally not taken into account by the simulator. Although the pre-layout simulation tests the circuit's operation in ideal, rather than real-life conditions, the simulation results are still useful as an initial test of the circuit's operation.

When the designer is satisfied with the pre-layout simulation results, it is time to layout the design physically on the IC silicon core. Layout tools help the designer map the individual circuit structures to physical locations on the IC core. In addition, layout tools help route a power-bus grid which supplies power to the IC core. Layout tools typically contain libraries with information regarding the physical and geometrical properties of the circuit structures created during the fabrication process. Using place-and-route algorithms, the layout tools “seed” the circuit structures along the power-bus grid.

Once the IC layout is completed, the layout tools back-annotate the original netlist with additional structural data such as parasitic resistance and capacitance values, as well as power-bus wire resistance parameters. The back-annotated netlist is then run through a post-layout simulation to ensure proper functionality. Post-layout simulation is expected to represent the IC's true performance, rigorously testing the actual loading of the circuits and power-bus lines. Post-layout simulation usually requires a long time to complete, typically taking several days to finish. Results from this simulation can reveal problems such as excessive power-bus voltage drop and electromigration, which are generally not discoverable during pre-layout simulation.

Voltage drop problems are a result of a large drop in voltage across a wire conducting an electric current. The amount of voltage drop across a wire is proportional to the amount of current the wire is conducting and the wire's internal resistance. One factor affecting a wire's resistance is its cross-sectional area. As the cross-sectional area of a wire is made smaller, the wire's resistance increases, causing a larger drop in voltage. A large voltage drop across a power-bus wire can cause a lower than desired level of voltage at a particular point in the IC. When this low voltage is used to supply power to a transistor, the transistor's output response time to a change in input signal generally slows down. This skews circuit timings and may lead to IC malfunctions if time critical operations are not performed when expected. If the voltage drop across the power-bus wire is even more severe, the logic errors may occur and the entire IC may not operate as expected.

Electromigration is caused when electrons flowing through a wire randomly collide into the atoms of the wire, “carrying” the atoms along their path and causing wire deterioration, much like ocean currents carry beach sand and cause beach erosion. Electromigration is generally most pronounced in thin wires with a relatively large amount of current flow (high current density).

Electromigration causes a gradual thinning out of the wire, thereby exacerbating the electromigration problem even more and creating a positive feedback effect. Electromigration typically leads to voltage drop across a wire, and eventually to a break in the wire.

One drawback of discovering voltage drop and electromigration problems after post-layout simulation relates to the amount of time required for the simulation to complete. There are often strong market pressures to design and manufacture a new IC in a very short time. Finding voltage drop and electromigration problems after post-layout simulation requires the designer to change the IC floor plan and re-run the layout and simulation tools. Such problems may add days, if not weeks to the design cycle time and can significantly decrease a product's competitive advantage. In addition, the post-layout simulation time makes testing and comparing several different power-bus grid designs extremely time consuming.

One solution in the prior art of avoiding voltage drop and electromigration problems is to use very conservative power estimates when designing the power-bus grid. Designers typically multiply the amount of current estimated to flow through the power-bus grid by a cushioning factor to avoid voltage drop and electromigration problems. These conservative estimates generally result in power-bus wire widths which are significantly thicker than actually necessary to supply power throughout the IC core.

A drawback of over-estimating circuit power requirements is a sub-optimal use of the IC's available silicon core space. Since each component and wire within an IC takes up room on the silicon core, IC designers typically try to decrease the size of these components and wires so that ever more powerful circuits can be constructed in the IC core. Having more room on the IC core allows designers to add more circuit components and increase the IC's functionality. Thus, power-bus wires designed thicker than actually needed tend to waste valuable room on the IC.

### SUMMARY OF THE INVENTION

In accordance with the present invention, the disadvantages and problems associated with eliminating voltage drop violations of a mask layout block have been substantially reduced or eliminated. In a particular embodiment, a method for eliminating voltage drop violations of a mask layout block includes automatic correction of voltage drop violations within mask layout block if identified, maintaining the process design rules (DRC Clean) and layout connectivity (LVS Clean) correctness.

In accordance with one embodiment of the present invention, an automated method for eliminating voltage drop violations of a mask layout block includes analyzing a selected polygon(s) or signals by their names in a mask layout block in GDSII format or any industry standard layout editor's database and obtaining one or more voltage drop information associated with the polygon from a technology or external constraints file. The method provides a violation marker associated with the selected position for the polygon that graphically represents a space, width or length in the mask layout block where the selected polygon's position complies with the voltage drop requirements.

In accordance with another embodiment of the present invention, an automated method for eliminating voltage drop violations of a mask layout block includes analyzing a selected polygon or signal by its name in a mask layout block and identifying a voltage drop violation in the mask layout block if the selected position, with or length of the polygon creates a voltage drop value which is not permitted according to a technology or external constraints file. If a voltage drop violation is identified, the system automatically correcting the violation by moving, adjusting or modifying the problematic polygon or polygons, maintaining the process design rules (DRC Clean) and layout connectivity (LVS Clean) correctness. The system works throughout entire layout block hierarchy.

In accordance with a further embodiment of the present invention, a computer system for eliminating voltage drop violations of a mask layout block includes a processing resource coupled to a computer readable memory. Processing instructions are encoded in the computer readable memory. When the processing instructions are executed by the processing resource, the instructions analyze a selected polygon or signal by its name in a mask layout block and identify a voltage drop violation in the mask layout block if the selected position is creating a voltage drop violations according to information extracted from a technology or external constraints file.

If the voltage drop violation is identified, the instructions automatically correcting it via adjusting, moving or modifying the analyzed polygon or signal, maintaining the process design rules (DRC Clean) and layout connectivity (LVS Clean) correctness.

Important technical advantages of certain embodiments of the present invention include a voltage drop Auto Correct (IR Drop Auto Correct) tool that automatically corrects voltage drop violations of a mask layout block while maintaining the process design rules (DRC Clean) and layout connectivity (LVS Clean) correctness. A layout designer may execute an IC layout block with voltage drop violations. The IR Drop Auto Correct tool highlights a violation marker that may represent a width, space or length in the layout block and eliminates the voltage drop violation according to technology or external constraints file. In addition the IR Drop Auto Correct tool provides an information window with the current and fixed voltage drop conditions related to the selected polygon or signal. The correction action may change polygon's width, length or space according to voltage drop rules taken from technology or external constraints file while maintaining the process design rules (DRC Clean) and layout connectivity (LVS Clean) correctness. In case of contacts or vias individual or multiple selections, the system will automatically adjust the amount of contacts or vias according to voltage drop rules taken from technology or external constraints file. The processed mask layout block, therefore, may be free of voltage drop violations.

Another important technical advantage of certain embodiments of the present invention includes IR Drop Auto Correct tool that significantly reduces the design time for an integrated circuit. In a typical integrated circuit design process, a voltage drop check (IR Drop Check) tool analyzes a mask layout file for voltage drop violations and identifies any violations in an output file. A layout designer may use the output file to manually eliminate the identified voltage drop violations. Then the same IC layout block needs to be re-checked for voltage drop again and also other checks like reliability (Electromigration & self heat), DRC (Design Rule Check) and LVS (Layout vs. Schematics) to make sure that the connectivity and geometrical sizes are still correct according to technology file and schematics respectfully. These repeated cycles are time consuming and tedious procedures that can be eliminated using the presented invention.

The time needed to complete the entire design process for the integrated circuit, therefore, may be substantially reduced since the steps of checking the layout with an IR Drop tool and manually correcting the identified voltage drop violations may be eliminated using the automated software as described in this invention.

All, some, or none of these technical advantages may be present in various embodiments of the present invention. Other technical advantages will be readily apparent to one skilled in the art from the following figures, descriptions, and claims.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 illustrates seven Metals wires. These wires are connected through VIAL (For Metal1 to Metal2 connection) and VIA2. (For Metal2 to Metal3 connection)

FIG. 2 illustrates seven Metals, each analyzed for voltage drop conditions, defined by the process technology and/or external constraints file. All Metal2 lines WIDTH was found smaller then required for voltage drop requirements. Metal3 line LENGTH was found shorter then required by voltage drop restrictions. The violation markers represent a voltage drop violations on the polygons that they are attached into.

Metal 2 wires have WIDTH violation shown by violation markers.

Metal 3 wire has LENGTH violation shown by violation markers.

FIG. 3 illustrates the Metal2 and Metal3 lines after the IR Drop Auto Correct tool correction action. The Metal2 lines are WIDER and include more VIA1's. The Metal3 line is LONGER and includes more VIA2. When hovering above the INFORMATION marker, option windows will appear with the option to ACCEPT the correction or to CANCEL it. User may choose to accept or cancel some of the corrections only.

FIG. 4 Illustrates top level IC layout block that includes sub-cells. The IR Drop Auto Correct tool checks the layout block fully hierarchically, marking all voltage drop violations using violation marker. Upon the user's acceptance all these violations will be automatically fixed.

FIG. 5 illustrates a flow chart for one example of a method for automatic elimination of voltage drop violations of a mask layout block in accordance with teachings of the present invention.

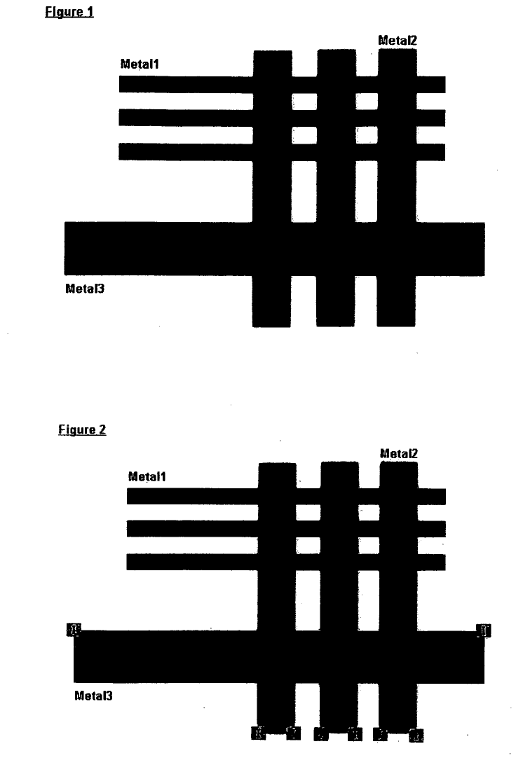

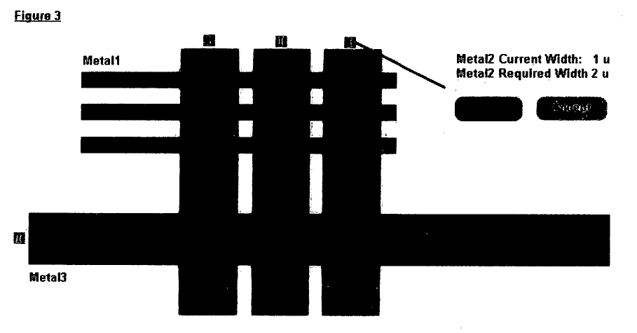

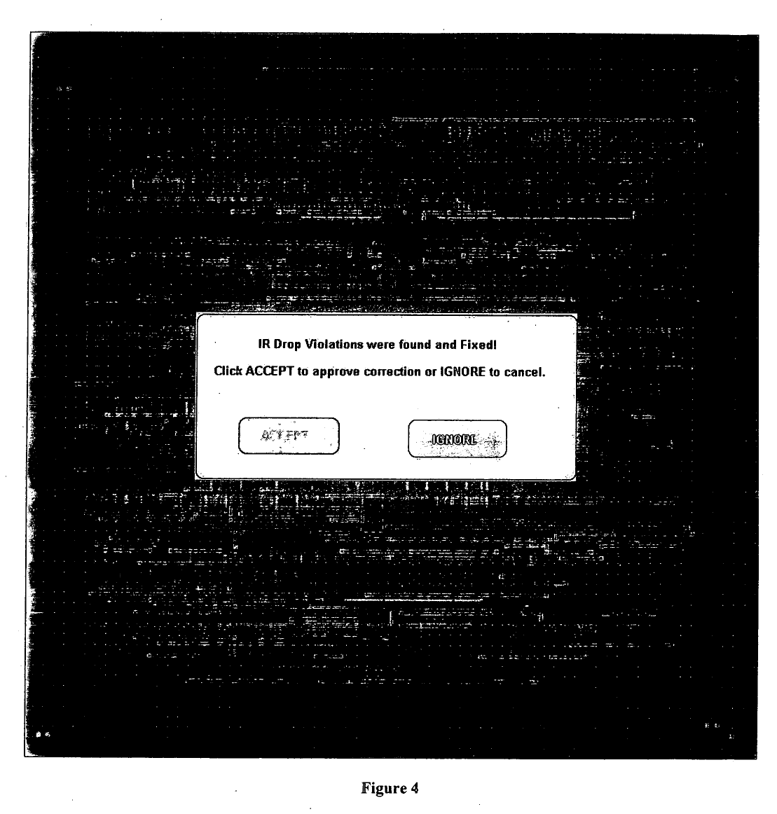

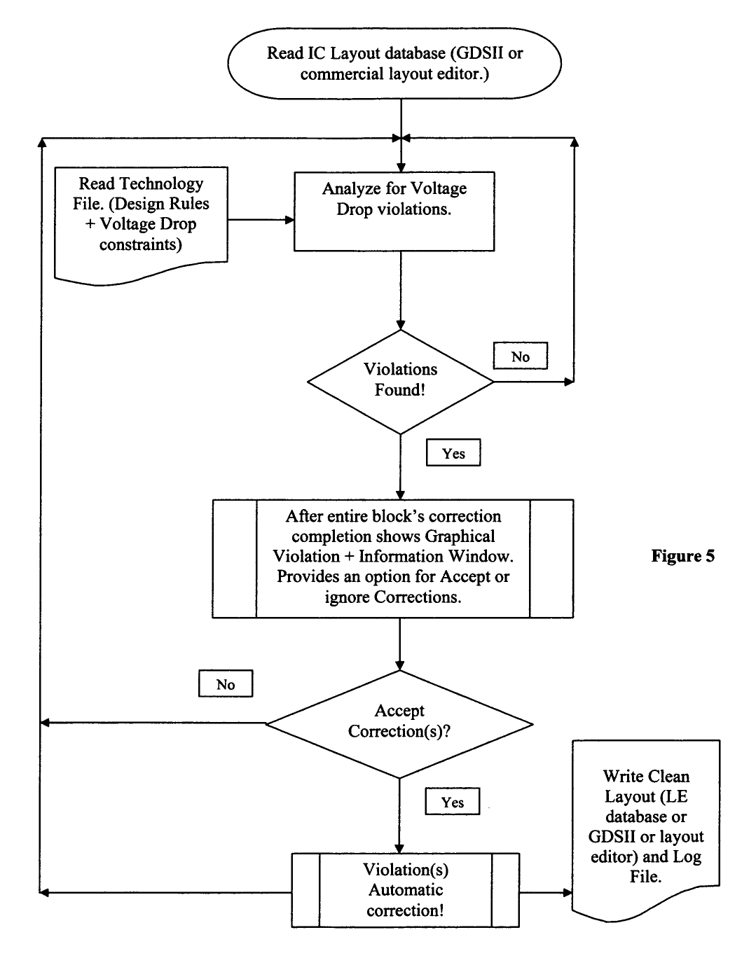

### DETAILED DESCRIPTION OF THE INVENTION

The processing instructions may include a commercially available layout editor interfaced with a voltage drop Auto correct (IR Drop Auto Correct) tool or an independent IC layout block in GDSII format or any other commercial format database. The IR Drop Auto Correct tool may provide the ability to analyze the width, length and placement of polygons in a mask layout block and determine if a voltage drop violation was created. In addition the IR Drop Auto Correct tool may provide the ability to analyze the number of contacts and VIA's, determine the amount needed in order to comply with voltage drop requirements. The IR Drop Auto Correct tool may automatically correct all voltage drop violation maintaining the process design rules (DRC Clean) and layout connectivity (LVS Clean) correctness.

After a layout designer creates a mask layout block it may contain voltage drop violations. The IR Drop Auto Correct tool reads the layout block information from GDSII format file or from industry standard layout editor's database system. In addition the IR Drop Auto Correct tool reads a technology and/or external constraints file corresponding to a desired manufacturing process. The technology file may contain design rules for the desired manufacturing process that ensures an integrated circuit fabricated on a semiconductor wafer, functions correctly. Furthermore, the tool has an option to read another constraints file which contains layout extraction information (resistance and capacitance values) per circuit net. Within the mask layout block, the voltage drop information may impact the minimum or maximum allowable feature dimensions (e.g., metal and polysilicons wires width, spaces and length) for the desired manufacturing process. In addition the voltage drop information may impact the correct number of contacts and VIA's in order to maintain accurate electrical current flow without causing metal lines failures. The IR Drop Auto Correct tool then uses the voltage drop information to automatically fix voltage drop violations of the mask layout block.

The IR Drop Auto Correct tool uses the voltage drop information to graphically display the violations through a violation marker layer that is provided with industry standard layout editors.

The IR Drop Auto Correct tool may graphically represent the violation marker in the mask layout block by highlighting the required width, length or space with an appropriate color and/or pattern. The violation marker color and/or pattern can be set in an initial tool setup. In addition the IR Drop Auto Correct tool may show an Information Window with the current and fixed results. The Information Window also provides with the option to accept the correct new layout or ignore the correction results.

After the IR Drop Auto Correct tool completed its automatic voltage drop correction, user may have the option to accept the corrected layout or to ignore it and return to the original layout cell. The IR Drop Auto Correct tool may guide the layout designer about voltage drop violations within the mask layout block using violation marker. If the layout designer chooses to comply with the voltage drop corrections, the IR Drop Auto Correct tool automatically creates new layout cell that includes all corrections and maintains the process design rules (DRC Clean) and layout connectivity (LVS Clean) correctness.

The IR Drop Auto Correct operates in flat mode and hierarchical mode. When layout designer chooses to work in hierarchical mode, the IR Drop Auto Correct tool will work throughout the entire hierarchy correcting all voltage drop violations, maintaining the process design rules (DRC Clean) and layout connectivity (LVS Clean) correctness. In Flat Mode the IR Drop Auto Correct tool will fix all voltage drop violations in the current cell level only, maintaining the process design rules (DRC Clean) and layout connectivity (LVS Clean) correctness.

The IR Drop Auto Correct tool is included an entire layout block Check mode. This mode is aimed to be activated with the completion of the entire layout block. Using this feature the entire block will be analyzed for voltage drop violations. When analysis is complete all violations will be shown using violation marker. This mode operates in flat or fully hierarchical mode.

The processing instructions for automatic correction of voltage drop violations in a mask layout file may be encoded in computer-usable media. Such computer-usable media may include, without limitation, storage media such as floppy disks, hard disks, CD-ROMS, DVDs, read-only memory, and random access memory; as well as communications media such wires, optical fibers, microwaves, radio waves, and other electromagnetic or optical carriers.

1. An automated method for eliminating voltage drop violations of a mask layout block, comprising: reading integrated circuit layout database in GDSII format or industry standards layout editor's database; analyzing polygons or signals by their names in the mask layout block for the existence of voltage drop violations; obtaining one or more voltage drop restriction information associated with the polygons or signals from a technology and/or external constraints file; providing an information window with the current and required integrated circuit voltage drop parameters and; providing a violation marker associated with the position of the polygons or signals, the violation marker operable to graphically represent a width, space, length or any other polygon's characteristic (Polygon's Metal type) in the mask layout block where polygons or signals complies with the voltage drop requirements; and automatically correct all voltage drop violations maintaining the process design rules (DRC Clean) and layout connectivity (LVS Clean) correctness.

2. A method as defined in claim 1, wherein the operation of analysis for voltage drop violations further includes: generating an equivalent circuit of the metals segments; simulating the equivalent circuit; and generating a representation of the current density of the equivalent circuit.

3. A method as defined in claim 2, wherein the equivalent circuit comprises a netlist.

4. A method as defined in claim 1, wherein the operation of analysis for voltage drop further includes: defining one or more current density threshold values; and indicating when the current density exceeds the one or more threshold values.

5. The method of claim 1, further comprising: analyzing the mask layout block for existence of voltage drop violations which are determined by a technology file and/or external constraints ASCII file which contains net's capacitance, resistance parameters and other integrated circuit relate reliability and electrical factors.

6. The method of claim 1, further comprising: determined if a selected area, through a selection box, contains sufficient amount of CONTACT or VIA polygons in order to comply with voltage drop restrictions, taken from a technology and/or external constraints file; and automatically modifying the amount of CONTACTS or VIA polygons according to voltage drop restrictions until matching the minimum required according to technology and/or external constraints file rule, maintaining the process design rules (DRC Clean) and layout connectivity (LVS Clean) correctness.

7. The method of claim 1, further comprising: determining if the position of the polygons or signals creates a feature dimension in the mask layout block (space, width or length) that causes a voltage drop violation; and correcting the selected position until the feature dimension is matching at least minimum voltage drop requirement, maintaining the process design rules (DRC Clean) and layout connectivity (LVS Clean) correctness.

8. The method of claim 1, further comprising the voltage drop information selected from a group consisting of a metals spacing, polysilicon spacing, contact spacing and all types of VIA spacing.

9. The method of claim 1, further comprising the voltage drop information selected from a group consisting of a metals length, polysilicon length, contact length and all types of VIA length.

10. The method of claim 1, further comprising the voltage drop information selected from a group consisting of a metals width, polysilicon width, contact width and all types of VIA width.

11. The method of claim 1, wherein the selected position for the polygon or signal comprises a location for the polygon in the mask layout block.

12. The method of claim 1, wherein the selected position for the polygon or signal comprises a location for edges of the polygon in the mask layout block.

13. The method of claim 1, wherein the mask layout block is hierarchical.

14. An automated method for eliminating voltage drop violations of a mask layout block, comprising: reading integrated circuit database file in GDSII format or commercial database format and; analyzing a selected polygon or signal in the mask layout block for the existence of voltage drop violations; providing a violation marker associated with the polygon or signal; determining if the selected position, width or length of the selected polygon or signal produces a voltage drop violation in the mask layout block based on a voltage drop information taken from a technology and/or external constraints file; and automatically correct the voltage drop violation if exists, maintaining the process design rules (DRC Clean) and layout connectivity (LVS Clean) correctness.

15. The method of claim 14, further comprising automatically placing polygons in an original position in the mask layout block if the voltage drop violation exists, maintaining the process design rules (DRC Clean) and layout connectivity (LVS Clean) correctness.

16. The method of claim 14, further comprising automatically adjusting the position of polygons until the voltage drop violation is eliminated, maintaining the process design rules (DRC Clean) and layout connectivity (LVS Clean) correctness.

17. The method of claim 14, further comprising automatically adjusting the width of polygons until the voltage drop violation is eliminated, maintaining the process design rules (DRC Clean) and layout connectivity (LVS Clean) correctness.

18. The method of claim 14, further comprising automatically adjusting the length of polygons until the voltage drop violation is eliminated, maintaining the process design rules (DRC Clean) and layout connectivity (LVS Clean) correctness.

19. The method of claim 14, further comprising automatically adjusting the amount of the contacts or VIAs until the voltage drop violation is eliminated, maintaining the process design rules (DRC Clean) and layout connectivity (LVS Clean) correctness.

20. The method of claim 14, wherein the mask layout block is hierarchical.

21. The method of claim 14, further comprising: the mask layout block including at least one top-level cell and one or more instances of a subcell located in the top-level cell; and determining if the position produces an voltage drop violation in one or more instances of a subcell in the mask layout block, the subcell located in a top-level cell; and simultaneously correcting voltage drop violation if exists, maintaining the process design rules (DRC Clean) and layout connectivity (LVS Clean) correctness.

22. The method of claim 14, further comprising generating a mask layout file from the mask layout block that does not include the voltage drop violation.

23. A computer system for eliminating voltage drop violations of a mask layout block, comprising: a processing resource; a computer readable memory; and processing instructions encoded in the computer readable memory, the processing instructions, when executed by the processing resource, operable to perform operations comprising: reading GDSII layout block or industry standard layout editor's database and; analyzing polygons or signals by their name in the mask layout block for the existence of voltage drop violations; providing a violation marker associated with the polygon or signal; providing an information window with the current and required integrated circuit voltage drop parameters; determining if position, width or length of polygons produces a voltage drop violation in the mask layout block based on an voltage drop information taken from a technology and/or external constraints file; and automatically correcting the voltage drop violation if exists, maintaining the process design rules (DRC Clean) and layout connectivity (LVS Clean) correctness.

24. The system of claim 23, further comprising the instructions operable to perform operations including automatically placing polygons in an original position in the mask layout block if the voltage drop exists, maintaining the process design rules (DRC Clean) and layout connectivity (LVS Clean) correctness.

25. The system of claim 23, further comprising the instructions operable to perform operations including automatically adjusting the selected position until the voltage drop violation is eliminated, maintaining the process design rules (DRC Clean) and layout connectivity (LVS Clean) correctness.

26. The system of claim 23, further comprising the instructions operable to perform operations including automatically adjusting the width and/or length of polygons until the voltage drop violation is eliminated, maintaining the process design rules (DRC Clean) and layout connectivity (LVS Clean) correctness.

27. The system of claim 23, further comprising the instructions operable to perform operations including automatically adjusting partial part of the polygon's width and/or length until the voltage drop violation is eliminated, maintaining the process design rules (DRC Clean) and layout connectivity (LVS Clean) correctness.

28. The system of claim 23, further comprising the instructions operable to perform operations including: determining if the position, width or length of a polygon creates a voltage drop violation in the mask layout block according to voltage drop information taken from a technology and/or external constraints file; and modifying polygons position, width or length until the voltage drop is approximately equal to the associated technology file information and/or complying with external constraints file rule according to priority.

29. Software for eliminating voltage drop violations of a mask layout block, the software being embodied in computer-readable media and when executed operable to: read integrated circuit database file in GDSII format or commercial formats database and; analyze polygons or signals by their name in the mask layout block for the existence of voltage drop violations; providing a violation marker associated with polygons; providing an information window with the current and required integrated circuit voltage drop parameters; and determining if the selected position, width or length of polygons produces an voltage drop violation in the mask layout block based on an voltage drop information from a technology and/or external constraints file; and automatically corrects the voltage drop violation if exists, maintaining the process design rules (DRC Clean) and layout connectivity (LVS Clean) correctness.

30. The software of claim 29, further operable to automatically place the polygon in an original position in the mask layout block if the voltage drop violation exists, maintaining the process design rules (DRC Clean) and layout connectivity (LVS Clean) correctness.

31. The software of claim 29, further operable to automatically adjust polygon's position, width and length until the voltage drop violation is eliminated, maintaining the process design rules (DRC Clean) and layout connectivity (LVS Clean) correctness.

32. The software of claim 29, further operable to automatically adjust polygon's position, partial width and length until the voltage drop violation is eliminated, maintaining the process design rules (DRC Clean) and layout connectivity (LVS Clean) correctness.

33. The software of claim 29, further operable to automatically adjust VIA's position and/or amount until the voltage drop violation is eliminated, maintaining the process design rules (DRC Clean) and layout connectivity (LVS Clean) correctness.

34. The software of claim 29, further operable to automatically adjust CONTACTS position and/or amount until the voltage drop violation is eliminated, maintaining the process design rules (DRC Clean) and layout connectivity (LVS Clean) correctness.

35. The software of claim 29, wherein the mask layout block is hierarchical.
